(19) United States
(12) Patent Application Publication
(10) Pub. No.: US 2019/0156612 A1
(43) Pub. Date: May 23, 2019

(54) Methods and Apparatus for Smart Vending Motor and Other Vending Component Control

(71) Applicant: Ellenby Technologies, Inc., Woodbury Heights, NJ (US)

(72) Inventors: Bob M. Dobbins, Villanova, PA (US); Aaron H. Dobbins, Cherry Hill, NJ (US); Robert D. Ross, Gibbsboro, NJ (US); Scott Barnes, Wenonah, NJ (US)

(21) Appl. No.: 16/193,738

(22) Filed: Nov. 16, 2018

Related U.S. Application Data
(60) Provisional application No. 62/589,142, filed on Nov. 21, 2017.

(51) Int. Cl. G07F 11/00; G07D 1/00

(52) U.S. Cl. CPC G07F 11/00; H04W 92/18; G07D 1/00

(57) ABSTRACT

A smart vend motor is described which may be deployed in a standard snack and candy vending machine, a coin and bill dispensing machine, or the like. Each smart vending motor has a local smart control able to determine if its corresponding smart vending motor has been selected for energization from a signal sent to multiple vend motors. This smart controller can also control operation of multiple additional devices, such as LEDs to light products, consumer information displays, and product drop detectors. In some applications, vending of multiple vend motors at the same time is supported.

The present application claims the benefit of U.S. Provisional Patent Application Ser. No. 62/589,142 filed Nov. 21, 2017 entitled “Methods and Apparatus for Smart Vending Motor and Other Vending Component Control” which is incorporated by reference herein in its entirety.

### FIELD OF THE INVENTION

The present invention relates generally to providing improved control arrangements for controlling vending machine components, such as vend motors, LED lighting components, product drop sensors and the like. More particularly the present invention addresses techniques for providing smart control functions in vending machine components, such as vend motors.

### BACKGROUND OF THE INVENTION

The current state of technology in the vending industry has been optimized over decades to allow for low cost vending of relatively low cost items, such as chips, candy, gum, soft drinks and the like. In particular, spiral based vending machines that can store and dispense a large variety of products have become a standard in snack food vending. These machines are typically configured so that products are arranged in rows (drawers) and columns (spirals). Product dispensing motors are typically wired in a matrix format so that applying power to a row and a column results in the motor at that intersection dispensing the product of the spiral driven by that motor. This is typically done by driving the spiral to advance the product until the product falls from the end of the spiral to a retrieval bin.

There are also many techniques that have been used to determine when the motor has rotated one revolution so the control electronics can stop driving the motor when it returns to the home position. One such home position detection arrangement can be seen in U.S. Pat. No. 4,785,927 assigned to Mars Inc. The described technique uses a high frequency signal imposed on the positive voltage line to the motor which is then passed through a capacitor and series resistor when a home switch is closed. The controller decodes the high frequency signed received when in the home position to determine when to power down the motor. Another home detection technique can be seen in U.S. Pat. No. 4,712,049 assigned to Coin Acceptors, Inc. which monitors the home switch arranged with the normal open and normal closed terminals tied together to detect the brief break before a make signal is generated when the home switch transitions to the home position.

Other motor home techniques include providing a separate home switch line to monitor the home position. In one currently employed approach, low cost geared dc brush motors are used with at least a mechanical switch to monitor the home position. The home line is switched between an open position to one of the motor power lines when the motor is in the home position. Generally, a drawer or row of motor home switches will be tied together or a column of motors will have their home switch lines tied together and brought back to the vending controller. The controller monitors the home switch line of the row or column of the motor being energized to determine its home position.

A relatively new class of vending machines uses a spiral drive arrangement to dispense rolled coins or bills as described in detail in U.S. Pat. Nos. 8,77,0372, 9,142,079, and 9,619,957, all of which are assigned to the assignee of the present invention and incorporated by reference herein in their entirety. In this machine the expectation is that multiple items will be selected and then vended. For example, a checkout clerk might desire $20 in change comprised of $10 of quarters (1 roll), $5 of dimes (1 roll), $4 of nickels (2 rolls) and $1 of pennies (2 rolls). In such a context, the present invention recognizes it may be highly desirable to drive multiple vend motors at the same time to speed the dispensing of these multiple items.

Vending machine wiring in such configurations as addressed above typically includes power (typically 24 VDC) being wired to each of the motor rows in common and the power return line (typically near 0 VDC) to be wired to each of the motor columns in common. The motors are each isolated with a diode to prevent several motors from turning when a given row and column is powered.

A typical vending machine may also include a product detect sensor system to determine if a product was truly delivered. If not, the motor may be tried a second or multiple times to ensure a product was vended. In the case no product was detected as vended after a predetermined number of tries, the money deposited would typically be returned to the consumer. Several techniques have been used to sense product delivery. Two such techniques can be seen in U.S. Pat. Nos. 6,794,634 and 7,446,302 assigned to Automatic Merchandising Systems Inc. Another such technique can be seen in U.S. Pat. No. 6,732,014 assigned to Crane. Yet other techniques can be seen in U.S. Pat. Nos. 6,920,372 and 8,234,007 assigned to Vendors Exchange. More advanced technologies combine monitoring for both product delivery and product availability as taught by the patents referenced above assigned to the assignee of the current invention.

Traditional glassfront vending machines also have lighting to ensure the products are easy to see and the pricing labels are easy to read. Historically, fluorescent lighting was used with one or two tubes placed on the top or sides of the door. More recently, LED lighting has replaced fluorescent lighting as the advantages of lower power, longevity, and the ability to control the light output allowed flexibility not available using fluorescent lighting. U.S. Pat. Nos. 9,593,811 and 9,816,673 assigned to the assignee of the present invention and incorporated by reference herein are examples of this technology.

The approaches of typical matrixed-motor vending machines have a number of drawbacks. Among these drawbacks is the requirement of a complex cable arrangement to bring separately controlled power to each row and column in the machine. Since each row and column is separately driven, each of these lines must originate at the drive control of the machine. Each of the rows and columns require individual drive components for the required individual motor controls. The cost of the wiring is high and growing as the cost of copper continues to rise. Additionally, the cost of creating the wire harness assembly and installing it into the machine is high as it is labor intense. Since it is typical for drawers to be pulled out or removed for filling product or for servicing, the length of these multi conductor cables can be quite long adding to their cost. Finally, in the case of a failure of a cable, connector or wire, considerable work is required by a service technician to identify the fault and repair or replace it.

Another drawback of the typical current arrangement is the limitations required on the choice of motors used in these machines. The motors must be essentially identical to allow proper operation. If a motor becomes obsolete, replacements are difficult to find as both the characteristics of the motor and its home circuitry must be matched with the other motors in the array.

The product sensing arrangements in the existing machines are typically designed to detect the product dropping from any row and column position into a retrieval bin. The detection schemes must be able to detect both the smallest product vended as well as the largest product vended. The system further needs to be immune to cheating by various means. All of these constraints add to the cost and limit the performance that can be achieved.

Lighting approaches in these machines may tend to result in inconsistent uniformity of lighting as the products near door mounted lights tend to be too bright, while those further away from the lights tend to be underlit. This issue can be overcome with additional lights resulting in higher cost and power use.

In many machines, product pricing is shown with stickers under the products and on the display when the particular product is selected. Some machines use individual pricing displays at each product location, but these require an additional set of cables and electronics to update and control.

### SUMMARY OF THE INVENTION

In view of the above and other shortcomings of typical approaches used in vending machines, one or more aspects of the present invention provide a number of improvements which address objectives such as the following.

One objective of one aspect of the present invention is to provide a smart motor assembly suitable for vending whereby any number of product selections can be accommodated without the need to predetermine the wire harness needed.

Another objective of the current invention is to provide a smart motor assembly that can be driven individually or with a number of smart motor assemblies mounted in a tray or drawer.

Yet another objective of the current invention is to provide multiple motor control with a single smart motor controller to synchronize motor operation when more than one motor is required to dispense an item.

Another objective of the current invention is to provide a smart motor controller for multiple motors organized in a tray or drawer so operation of any of the motors in a tray can be controller with a single smart motor controller.

A further objective of the current invention is to provide a smart motor assembly with a common supply rail, supply return rail, and serial communications lines with other smart motor assemblies in the vending machine.

Another objective of the current invention is to provide a smart motor assembly able to determine the home position of the motor and communicate this determination through the serial interface to a vending machine controller.

Yet another objective of the current invention is to provide a smart motor assembly which can use a dc brush motor, dc brushless motor, stepper motor, ac motor, or any appropriately sized motor as alternatives as technologies dictate motor choice. Thus, if one motor fails or it becomes desirable to replace an existing motor for any reason, it will be possible to replace it with a different motor.

A further objective of the current invention is to provide direct monitoring of the home position of the motor used in the smart motor assembly with or without the use of a mechanical switch. Characteristics of the motor, optical sensing, magnetic sensing and the like are some options for home detection.

Another objective of the current invention is to allow for independent and multiple motor operations to allow multiple products to be vended simultaneously.

Yet another objective is to supply diagnostic information from the smart motor assemblies to the controller to facilitate service.

An additional objective of the current invention is to provide for LED lighting at each product location which is individually controllable by the controller.

Yet another objective of the current invention is to provide individually controllable product pricing or other consumer information, such as product calories, at each product.

Yet another objective of the current invention is to provide individual speed control of each smart motor assembly.

Another objective of the current invention is to provide remote (Bluetooth®, WiFi, ZigBee and the like) wireless access of the smart motor from a smart device, such as a smart phone, to eliminate the need for a vending controller.

A more complete understanding of the present invention, as well as other features and advantages of the invention, will be apparent form the following detailed description, the accompanying drawings, and the claims.

### BRIEF DESCRIPTION OF THE DRAWINGS

FIG. 1 shows a block diagram of a typical vending machine showing an example of a motor control and interface of the prior art.

FIG. 2 shows a block diagram of a smart motor according to an embodiment of the present invention.

FIG. 3 shows a block diagram of one embodiment of a vending machine in accordance with an embodiment of the invention using multiple smart motors as shown in FIG. 2.

FIG. 4 shows a block diagram of a second embodiment of a vending machine using the smart motor of FIG. 2.

FIG. 5 shows a block diagram of another embodiment of a smart motor of the present invention controlling more than one motor and illustrating additional aspects of motor control capability in accordance with the present invention.

### DETAILED DESCRIPTION

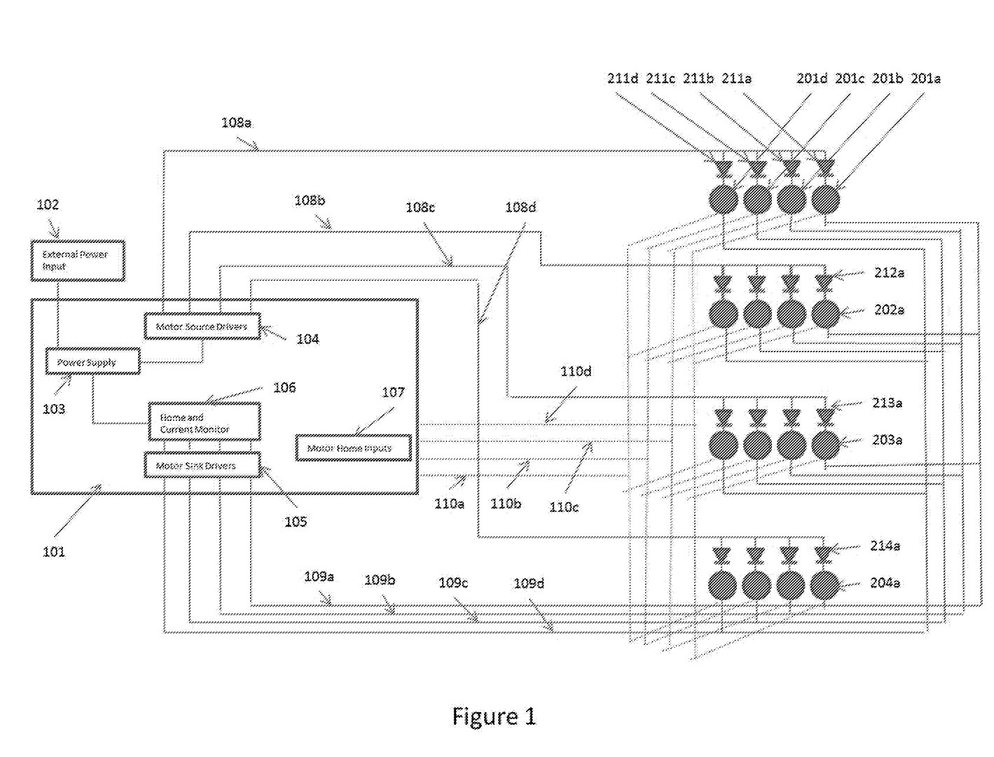

The current invention redefines the architecture of the typical multi-product dispensing vending machine using a matrixed product dispensing arrangement. As discussed above, this arrangement has been widely used in both glassfront vending machines and many enclosed vending machines such as the Ellen by Technologies, Inc. rolled coin dispensing machine described above. The many advantages of the architecture of the current invention are best understood with a recap of the current technology topology as shown in FIG. 1 and described below.

FIG. 1 is a limited block diagram of one current technology matrix motor architecture. The operation of this type of vending machine is well known in the art and will not be discussed at length here. Instead, the detailed discussion of controller 101 is limited to the motor interface components. The controller 101 is usually found in the vending machine and normally controls not only the vending motors, but also the user interface as well as the payment interface. Key to the present discussion is the area of the controller relevant to the motor matrix control. The power input 102 to the controller 101 is usually provided by a separate component of the vending machine and may consist of transformers, linear power supplies or switching power supplies. The type and choice of power supplies is not relevant to the current production and is well known in the art.

Within the controller 101 the power input 102 will be processed by the on board power supply 103 to create the various voltages needed to run both the electronics within the controller, the external payment devices, user interface as well as the motors. In the matrixed motor vending application, a number of motor assemblies are usually positioned in a series of trays. Each tray or row of motors will be driven by a source of voltage reserved for that tray. FIG. 1 shows four trays of four motor assemblies. The first tray includes motor assemblies 201a, 201b, 201c, 201d, each isolated by diodes 211a, 211b, 211c, and 211d, respectively, and powered by the source of power line 108a. The second tray is similar and is represented by motor assembly 202a and its associated isolation diode 212a along with three other motor assemblies and their respective diodes. The second tray is powered by power line 108b. Similarly, the third tray is represented by the motor assembly 203a and its isolation diode 213a is powered by power line 108c. Finally, the fourth tray is represented by the motor assembly 204a and its isolation diode 214a is powered by power line 108d. It should be clear that the four tray example with each of four motors is for illustrative purposes only and any desired number of trays and motors per tray can be used as desired consistent with the size constraints of the vending machine.

The motor source power lines 108a, 108b, 108c, and 108d are each controlled by motor drivers 104 on the controller 101. These drivers can be FET, bipolar transistors, relays, or any other electronically controlled switching devices under the control of the processor programmed to turn a specific motor assembly on.

Similarly, each motor assembly's return line is associated with a motor sink driver 105. The current passing through the motor sink driver 105 may also pass through a home and current monitor detector 106 which may determine if the motor is in its home position and/or operating properly as its current is within normal bounds. The current returns to the circuit ground completing the circuit and allowing the motor to energize. The motor assembly return lines allow a motor from each tray to be wired in common forming the columns in the matrix. So, the motor assembly 201a from tray 1 is wired on the return side to return wire 109a and motor sink drive 105. The motor assembly 202a from tray 2 is wired on the return side to return wire 109a again and to motor sink driver 105. Similarly, the return wires from the first motor in tray 3 and tray 4 are also tied to 109a and sink driver 105.

The second motor in tray 1 201b along with the second motors in each of trays 2, 3, and 4, are returned to the return wire 109b and to its motor sink drive 105 and home and current monitor circuit 106 to complete the path for each of these motors. Columns 3 and 4 which include tray 1 motor assemblies 201c and 201d respectively will return on return lines 109c and 109d respectively to their motor sink drivers 105 and home and current monitor 106 back to circuit ground from power supply 103.

As can be appreciated, the number of source lines and sink lines will equal to the number of trays and the number of columns in the machine, respectively. Hence, in the current example, four source and four sink lines are routed through the vending machine from the controller 101 to the various motor assemblies. Once a single source driver is energized and a single sink driver is energized a single motor assembly will be energized. The isolation diodes shown on each motor assembly, 211a, 211b, 211c, 211d, 212a-d, 213a-d, and 214a-d, are required to prevent the unwanted energizing of other motors as without these diodes the source and sink on one motor will be split across a number of combinations of three different motors resulting in some of these motors to be energized at a reduced voltage, an unwanted condition. This problem is well known in the art and all such motor matrix arrangements include these isolation diodes.

Each of the motor assemblies in the motor matrix configuration is energized until a home position is reached. As discussed above, there are many techniques for determining the home position including returning a separate wire back to the controller 101 indicative of the home position. If a separate wire is returned, it is usually associated with one tray or one column. The example shown in FIG. 1 shows the wires returned if each of the motor assemblies shared a home signal with their respective column mates. The home return for motor assembly 201a is shown by wire 110d and is shared with the home return for motor assembly 202a, 203a, and 204a. This motor home line 110d is shown returning to the controller 101 and processed through the motor home inputs 107. Similarly, motor home lines 110a, 110b and 110c are returned to the controller 101 and processed through the motor home inputs 107.

In many cases the motor home signal is superimposed on the return lines in common (high frequency signals, momentary loss of signals, etc.) with the return current and decoded on the controller 101 by the home and current monitor circuit 106.

Among its several aspects the present invention recognizes that the motor matrix approach of FIG. 1 has several disadvantages that the industry has been forced to endure. One of these limitations is that only one motor per column or row depending on the design of the matrix can be driven at a time. Another limitation is the complex nature and high cost of the machine cabling required to provide power and to control these motor assemblies. Another limitation is the lack of flexibility to configure machines to accommodate a variety of product dispense options without excessive wiring anticipating a change in future needs.

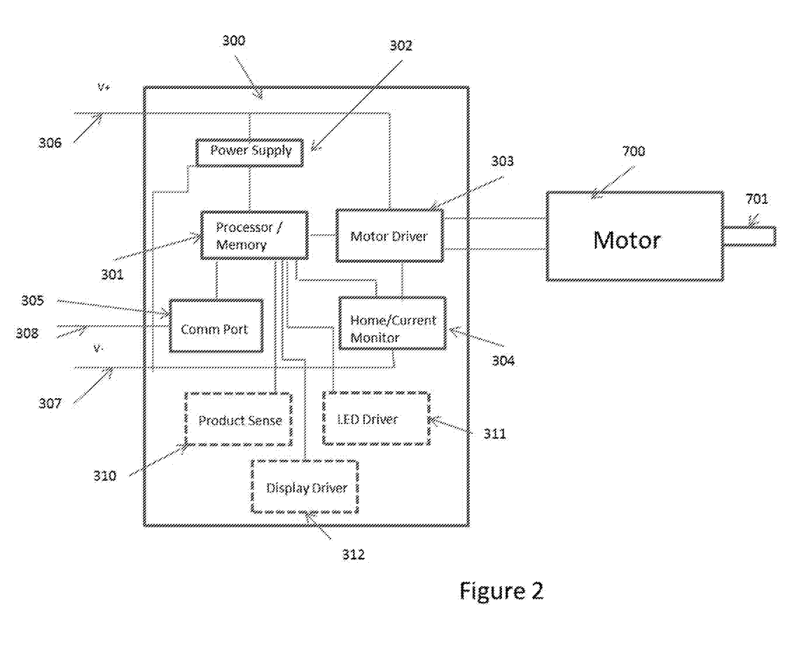

Referring now to FIG. 2, a block diagram of a smart motor assembly in accordance with the present invention is shown. The motor 700 has a small motor controller 300 mounted to it or near it so that its control is local to the motor 700 as is described further below. The shaft 701 of the motor is mechanically connected to the vending channel in one of several ways well known in the art. Most typically a spiral is used which pushes a product out with each revolution of the motor but the shaft 701 could also be used to drive belts or roller drives to advance product forward. The motor controller 300 includes a processor and memory 301 which contains the program required to drive the motor, monitor status and handle a number of additional features as desired.

In particular, the processor can be programmed to drive the motor 700 through a motor driver circuit 303. One significant advantage of the current invention is there is no restriction on the type of motor being used. The processor 301 and motor driver 303 can be adapted to any type of motor 700. So, while small brush DC motors are currently prevalent in vending, the limitations of using this type of motor are eliminated with the current approach. For example, with the control arrangement of the present invention, a brushless DC motor or a stepper motor can be used instead. The motor driver 303 used would be suitable to the type of motor used and may have multiple outputs to drive multiple phases of these alternate types of motors. Since only one motor 700 is driven by each motor driver circuit 303, there is no need for an isolation diode in the motor circuit so the vending mechanism in the current invention can utilized to drive the motor 700 in the forward or reverse direction as desired.

In addition to the direct motor control capability of the controller 300, the controller 300 also can monitor motor position including the home position or depending on the motor type with the actual rotational position of the motor being monitored through the home and current monitor circuit 304.

A small power supply circuit 302 is included on the controller 300 if needed to provide the power to the electronics on the controller 300 as well as any power required for some additional enhanced capabilities discussed below.

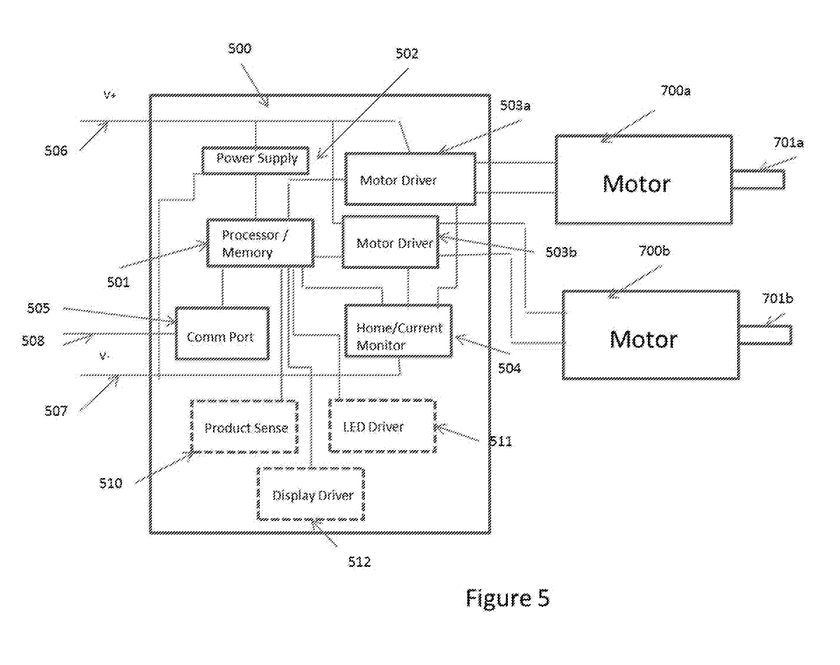

Referring now to FIG. 5, a smart motor controller 500 is shown having multiple motor drive circuits, two circuits 503a and 503b are shown for ease of illustration. These circuits control multiple motors 500a and 500b, again only two are shown though it will be recognized additional motors will typically be employed and controlled. A home/current monitor circuit 504 is preferably designed to allow the return lines from each of the multiple motors 500a and 500b returned through multiple motor drive circuits 503a and 503b. This multi motor smart controller approach addresses at least two machine cases efficiently. The first case is to address products that require more than one motor to dispense. The current invention allows the two motors to be synchronized for smooth operation. The second case is to allow a single smart motor controller to address several motors in close proximity such as on a common shelf to be controlled.

In its most basic operational mode, the controller 500 communicates with the vending controller communications port 504, through a communications port 505 by a communication bus 507. The communications in one embodiment of the present invention is through a serial RS485 port, but other suitable communication techniques can be used. A presently preferred communication means is one that uses a common bus for all the controllers 500 in the machine so only two or three common wires are daisy chained to all these motor controllers 500. It can be appreciated that the communications port 505 can also be a wireless communications port such as Bluetooth®, WiFi, or any appropriate relatively short range system. Each smart motor controller 500 would be uniquely addressed so that any particular motor controller 500 would only respond to a communication meant for it. A typical communication would have a “vend one product” command from the vending controller and a “successful product vended” response command from the smart motor controller 500. A number of other commands would allow diagnostic commands to be sent between the motor controller 500 and the vending controller. In this way, unless there is a fault, the vending controller does not need to monitor the real time state of each motor and whether it is in the home position or not, as this is controlled locally at the smart motor assembly.

The current inventive smart motor assembly can be programmed to allow it to be a host to a second or multiple other smart motor assemblies. This approach would allow large products that may need two motors to vend to be treated by the host controller as one. One of the smart motor assemblies can be master to the second smart motor assembly and manage the vend and home (and other features as discussed below) to create a super smart motor assembly. This super smart motor assembly would be treated as a single smart motor assembly by the vending machine controller or external controller.

There are a number of functions in a vending machine in addition to the motor control functions that currently require independent systems to monitor and control. The smart motor concept allows many of these systems to be distributed to each smart motor for better control and enhanced capability. A number of these systems are described below.

Most vending machines today have a product vend detection circuit to ensure the selected product has been delivered (and not stuck in a spiral or from an empty column). The current invention allows the product drop sensor to be monitored by the smart motor controller 500 through the product sense electronics 510. Since the product drop sensors would be best placed at the drop point in each smart motor assembly, an additional cable the length of the assembly would be needed to properly place the sensor, not shown.

Fortunately, the drop point in each smart motor assembly is also an advantageous place to put a lighting device such as an LED to directly light the product in the column controlled by the smart motor assembly. This LED can also be controlled by the smart motor controller 500 through an LED driver circuit 511. Of course, other light sources than LEDs can be used. In this manner, special use of lighting can allow for dimming or brightening the light on a specific product or products to call attention to these products. Additionally, color lighting can be used for the same purpose. The vending machine controller can send a command to turn on the LED at a given light level or color to the smart motor controller 300. Alternatively, the smart motor could be pre-programmed with a lighting sequence (such as a low light level until a product is vending during which the light is increased).

The smart motor controller 500 can also be used to drive a local display to allow product pricing, location identification, calories and other product information to be shown to the consumer for the product being vended. The display could be LCD, OLED or other convenient type that would only have to be wired back to the smart display controller 300. Again, communications back to the vending controller can determine the information to be displayed and instructions on when to display each message. This arrangement allows the placement of the display where it is best serving the consumer with little burden on the vending controller to manage. It should be clear that other product or motor related items can be controlled similarly by the smart motor controller with no additional wires or complication needed at the vending controller. The use of the smart motor assembly allows a significantly simplified vending controller and machine wiring to be used.

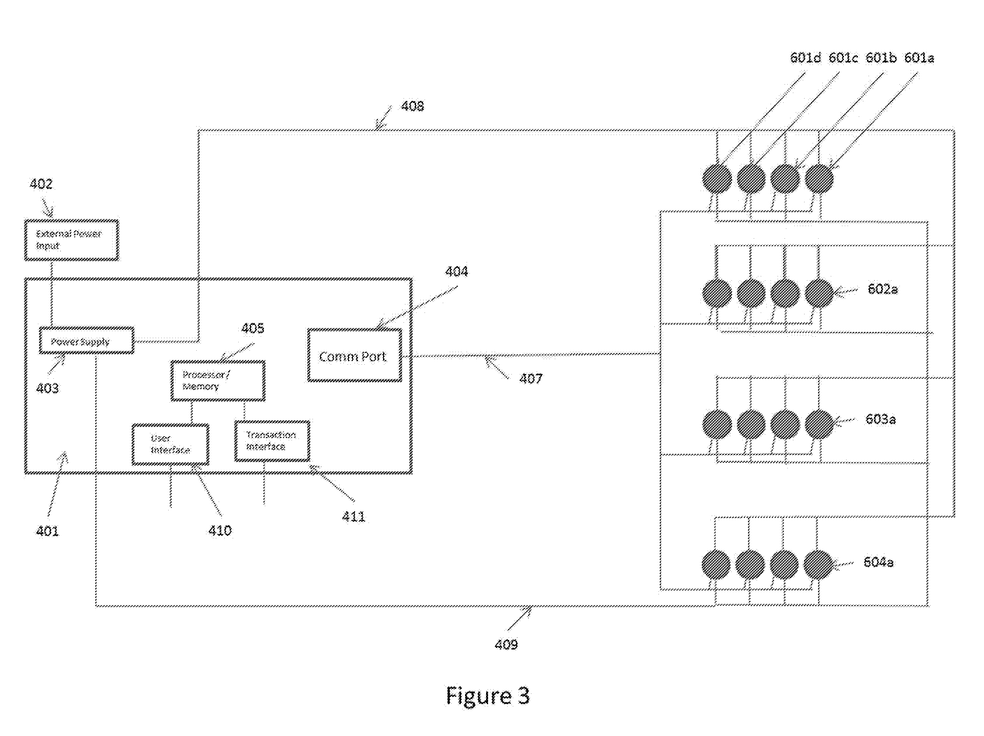

Referring back now to FIG. 3, the simplified motor control portion of a vending controller 401 is shown along with the resulting wiring. The vending machine will still need an external (to the controller) power supply 402 to power the machine and motors. It should be noted the typical controller also contains a processor and memory component 405 to control the vending machine inclusive of the motors as discussed below and to interface to the transaction devices (coin validator, bill acceptor, card readers, etc.) as shown by transaction interface 411. The user interface 410 is also controlled by the vending controller 401 in the current invention. However, the only power lines required to be distributed to the motor assemblies are the positive 408 and return 409 lines that are common to all the smart motor assemblies. The positive supply line 408 is identical to line 306 in FIG. 2 and line 506 in FIG. 5 and the return lines are identical to line 307 in FIG. 2 and line 507 in FIG. 5. The vending machine of FIG. 3 shows the smart motor assemblies distributed with motors arranged as in the prior art vending machine configuration shown in FIG. 1. Smart motor assemblies 601a, 601b, 601c, and 601d are shown representing the first row or tray in a machine similar to that shown in FIG. 1, but with only the common positive voltage 408 and return voltage 409 common to all four of these smart motor assemblies. Similarly, smart motors 602a, 603a, and 604a are representative of the smart motor assemblies in each of the other three rows, all shown with the same common voltage supplies 408 and 409.

Each of the smart motor assemblies discussed above include another common set of wires 407 and 507 used for communications to the vending controller 401 and 501 through the communications port 404 and 504. Commands generated by the vending controller 401 and 501through the communications port 404 and 504 are sent to all the smart motor assemblies and each smart motor assembly will only react and respond to commands with its specific and unique address. Thus, multiple smart motor assemblies can be instructed to vend at the same time. Optionally, every smart motor assembly can be individually instructed to turn on its LED light or display the product cost with this architecture.

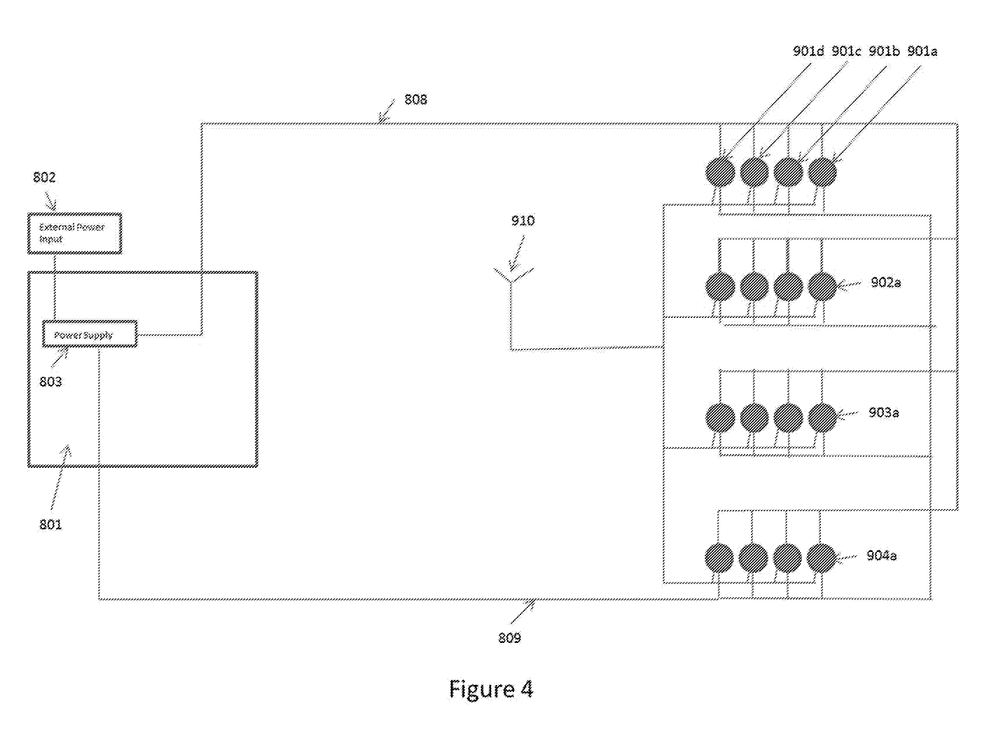

Another embodiment of the current invention is shown in FIG. 4 which is a block diagram of a vending machine that provides only power 808 and return 809 lines to the smart motor assemblies. In this example, the vending machine still requires an external power supply 802 for all devices in the machine and may require a vending controller 801 for the peripheral payment systems, but could also work without a vending controller as shown. The vending control signals could be provided utilizing a smart external device only or directly to a remote host system.

The communications port 308 in the smart motor assemblies of FIG. 2 can provide communications through a number of wireless options. The wireless technology can be part of each smart motor assembly as shown and represented by the antenna 910. Alternatively, a common wireless module can be used to interface to each smart motor's communications port to generate the needed wireless communications to an external transceiver. This approach allows an external smart device, such as a smart phone running a vending machine control application, to communicate directly with each smart motor to allow the vend to take place. In this case, the smart device would be expected to first process the payment, also through a number of possible known systems or payment platforms, and take the place of the vending controller. These smart phones can use a number of apps developed (or to be developed) to eliminate the need for anything but communications to the smart motors to vend. Controlling the smart motor assembly by such a smart or remote device would likely require additional protocol enhancements such as encrypted commands and a means to authenticate the source of the commands to prevent hacking. In this embodiment, the vending machine would not need any transaction devices or controller and would be essentially a box to hold the smart motors and products. The current invention allows a smart motor assembly as described to be a self-contained vending machine of one motor assembly or multiple motor assemblies with little but a box to mount the assembly required. This would allow a very cost effective, small dedicated vendor to address high value, limited selection vending to be addressed.

While the present invention has been disclosed in the context of various aspects of presently preferred embodiments, it will be recognized that the invention may be suitably applied to other environments consistent with the claims which follow.

I claim:

1. A vending machine comprising:
a plurality of smart vend motors arranged to cause vending of products;
a controller to send a control signal or command to the plurality of smart vend motors directing at least one identified smart vend motor from the plurality of smart vend motors to vend; and
each of the plurality of smart vend motors including a local smart control able to determine whether the control signal sent from the controller identifies that particular smart vend motor to vend.

2. The vending machine of claim 1 wherein said control signal directs two or more of the plurality of smart vend motors to vend causing two or more vend motors to vend at the same time.

3. The vending machine of claim 1 further comprising:
a plurality of devices controlled by the local smart controls of the plurality of smart vend motors.

4. The vending machine of claim 3 wherein the plurality of devices comprises LEDs arranged to light the products to be vended or displays arranged to provide consumer information for the products to be vended.

5. The vending machine of claim 1 wherein said controller comprises an external smart device and the local smart control further comprises a communication circuit for wireless communication.

6. The vending machine of claim 1 wherein the local smart control is able to detect position of its corresponding smart vend motor and communicate said position back to the controller.

7. The vending machine of claim 1 wherein the smart control is further able to control a corresponding product drop detection sensor.

8. The vending machine of claim 1 wherein the products vended are coins and bills.
